(19) United States
(12) Patent Application Publication
(10) Pub. No.: US 2012/0326349 A1
(43) Pub. Date: Dec. 27, 2012

(54) METHOD FOR PRODUCING A PARTICLE-BASED ELEMENT

(75) Inventor: Martin Denesi, Zvolen (CZ)

(73) Assignee: DASCANOVA GMBH, Linz (AT)

(21) Appl. No.: 13/520,499

(22) PCT Filed: Dec. 22, 2010
(86) PCT No.: PCT/EP2010/007895

§ 371 Date: Sep. 13, 2012

(30) Foreign Application Priority Data
Jan. 4, 2010 (DE) 10 2010 004 029.0

(51) Int. Cl. B29C 45/16

(52) U.S. Cl. 264/113

(57) ABSTRACT

The invention relates to a method for producing a particle-based element, especially a chipboard or fiberboard, a particle mass having a plurality of particles being provided. A first part of the particle mass is arranged in a desired matrix consisting of a second part of the particle mass in a targeted manner when the particle mass is provided, the first part of the particle mass and the second part of the particle mass having different compressive properties. The provided particle mass is compressed.

The present invention relates to a method for producing a particle-based element, in particular a chipboard or a fiberboard, respectively. Such a method generically comprises to provide a particle mass having a plurality of particles and to compress the particle mass.

For example, international patent application WO 2005/046950 A1 discloses to arrange wood particles and to compress the latter to form a particle-based plate, an area of increased density being obtained by arranging a higher number of particles in this area. Thus, increased strength is locally achieved across the total cross-section from the top side to the bottom side of the plate. However, the weight of the plate is considerably increased, and the global structural stability of the plate is not essentially improved.

In U.S. Pat. No. 6,511,567 B1, a wood component is disclosed in which an intermediate element is disposed between a top and a bottom plate such that cavities are formed. The manufacture of such a wood component permits to save material, however, the production process is relatively complicated. Moreover, the cavities can have negative effects in many fields of application, e.g. if fasteners are to be attached to the component, or if the component is to withstand a pressure load.

In a non-generic field of technology, US patent specification U.S. Pat. No. 3,385,749 discloses a glass-fiber reinforced element in which different amounts of glass fibers are arranged in a foamed matrix to obtain high structural stability at low weight.

It is the object of the present invention to provide a method for producing a particle-based element that can be carried out economically and permits the manufacture of particle-based elements with tailored structural properties.

This is achieved by selectively arranging a first part of the particle mass in a desired matrix consisting of a second part of the particle mass while the particle mass is being provided, the first part of the particle mass and the second part of the particle mass having different compressive properties. Due to the different compressive properties and to the fact that part of the particle mass forms a matrix one can form a structure having various advantages within the particle-based element. For example, by such an arrangement, above all the structural stability of the particle-based element can be increased. However, it is also conceivable to produce a particle-based element that is flexible though resistant by another selection of the compressive properties and/or the arrangement of the first part. The method is also suited for other purposes of the selective arrangement of materials with different properties.

In one embodiment, the particle mass is compressed into a particle-based element with areas of different densities, the particle mass comprising particles with essentially identical densities before compression. In areas of lower compression resistance, an area of higher density is thus created, whereby a purposeful density distribution can be achieved in the particle-based element by a simple method. The areas of higher density advantageously comprise a higher stability and thus permit an essential improvement of the structural stability, while the weight of the particle-based element is only slightly increased. As an alternative, however, a selective design of the flexibility of the component is also possible.

Advantageously, the second part of the particle mass is disposed in a continuous matrix. Thus, the second part forms a structurally continuous form in which the first part of the particle mass is arranged. The second part of the particle mass thus determines the global structural properties of the particle-based element, while the first part of the particle mass influences the local properties in the area where it is arranged, but also global properties, such as the weight of the particle-based element.

In one embodiment, the second part of the particle mass is arranged in a grid structure. A grid structure permits a uniform distribution of the second part of the particle mass, and thus in particular an improvement of the structural stability of the particle-based element.

Advantageously, the second part of the particle mass is compressed to a greater extent than the first part of the particle mass during compression. By this higher compression, the second part of the particle mass forms a structurally more stable element which reinforces the particle-based element. Furthermore, this permits to produce, in only one compression operation, a component with areas of different material compressions.

As an alternative, however, the first part of the particle mass can be compressed to a greater extent than the second part of the particle mass during compression. In this case, it is not the matrix, which consists of the second part of the particle mass, that is the more compressed part, but the first part arranged in it. Thus, the properties of the particle-based element can also be influenced in a different way, for example by a selectively more flexible design of the particle-based element.

In one embodiment, the second part of the particle mass can be formed in waves in the longitudinal direction of the particle-based element between a bottom side area and a top side area of the particle-based element. The wavy design of the second part of the particle mass permits an increase in the structural stability of the particle-based element because an increase of the geometrical moment of inertia can be effected by reinforced areas outside the neutral fiber of the particle-based element. Moreover, the bottom side area and the top side area of the particle-based element are structurally connected by the second part of the particle mass, which can further increase stability, in particular because in many particle-based elements, the top side area and the bottom side area are of higher stability and hardness than the inner area of the element.

Advantageously, the second part of the particle mass is furthermore formed to be wavy in the width direction of the particle-based element. Thus, an essential increase in the structural stability in the width direction as well as in the longitudinal direction of the element can be permitted.

In one embodiment, different types of particles are disposed in the particle-based element. The different types of particles can have different compressive properties, but also a plurality of further different characteristics, for example differences in the density, deformability, hardness, brittleness, behavior at rupture, abrasive behavior, elasticity, shape, magnetic permeability, thermal properties, the viscosity of the particle mass, melting behavior, boiling behavior, electric conductivity and/or light stability.

In one embodiment, when the particle mass is provided, a first type of particles is conveyed, and a second type of particles is supplied to the first type of particles by a particle supply tool before the particle mass is compressed. Thus, a flowing procedure can be implemented for the production of the particle-based element, permitting an efficient, continuous and thus inexpensive production.

In another embodiment, a different treatment of the first and/or the second part of the particle mass is carried out. By the treatment, the compressive properties of the particle mass can be changed. However, it is in general also possible to change further properties of the particle mass by the treatment.

In particular, the treatment of a part of the particle mass can comprise the incorporation of a chemical agent. One possibility is here the incorporation of an adhesive and/or hardener to precompact parts of the particle mass and thus change their compressive properties towards less compressibility. On the other hand, it is also possible to incorporate chemical agents which soften the particle mass, so that then compressibility is higher in these areas.

The treatment of a part of the particle mass can also be effected by introducing water. A particle mass which consists, for example, of wood fibers or similar fibrous materials is softened by introducing water and thus has a higher compressibility, so that this part can be compressed to a greater extent during compression. On the other hand, the introduction of water can lead, with a plurality of organic fiber materials, to the dissolution of natural adhesives which can solidify, after curing, that part of the particle mass into which water was introduced.

The treatment of a part of the particle mass can be effected by introducing energy, in particular by a heat treatment. The introduction of energy, in particular heat, can change the properties of the fibers in view of their compressibility. In particular, a conglutination of the fibers can be achieved if energy is introduced in combination with the introduction of an adhesive and/or hardener.

In one embodiment, the particle mass is conveyed in the longitudinal direction during treatment, and treatment is accomplished with a tool disposed within the particle mass, the tool being moved in the vertical direction of the particle mass. By this, one can achieve that local treatment can be selectively effected within the not yet compressed particle mass, permitting in a simple and inexpensive manner to also arrange more complex structures of differently treated areas in the particle mass.

The tool can extend in waveform with respect to the longitudinal direction. By the combination of a tool extending in waveform with respect to the longitudinal direction and being moved in the vertical direction, a wavy design of the treated part of the particle mass in the longitudinal as well as in the width directions can be effected.

In one embodiment, an expandable agent can be introduced into a first part of the particle mass, the expandable agent expanding within the particle mass after compression into a foam. In the process, the introduction of the foam influences the compressibility of the particle mass in this area and furthermore permits an additional expansion after compression that reduces the density of the particle mass in this area and thus permits to reduce the weight of the particle-based element.

The particles of the particle mass are preferably chiplike and/or fibrous. In particular, wood chips and/or natural fibers are used. However, it is also possible to use plastic chips.

The particle-based element is preferably plate-like.

Below, preferred embodiments of the inventive method will be described with reference to drawings.

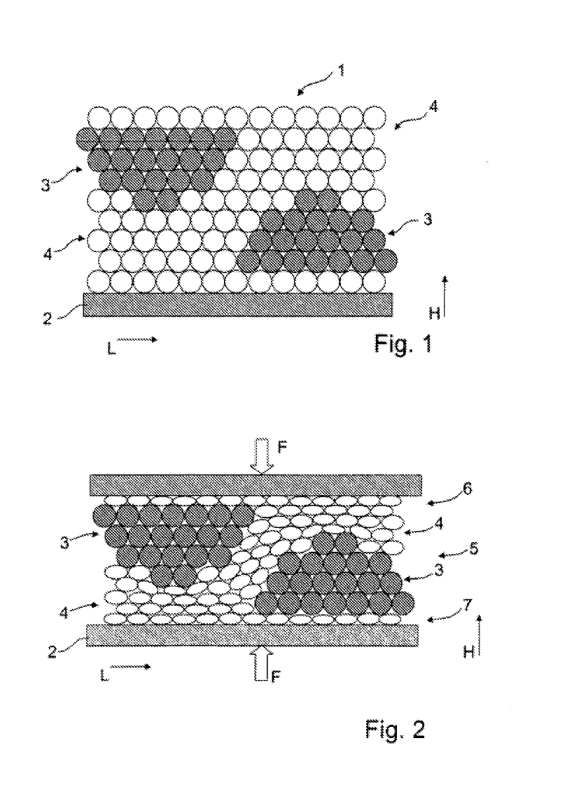

FIG. 1 shows a sectional view of a provided particle mass in one embodiment of the method according to the invention;

FIG. 2 shows a sectional view of the particle mass during the compression operation in the embodiment of the method according to the invention;

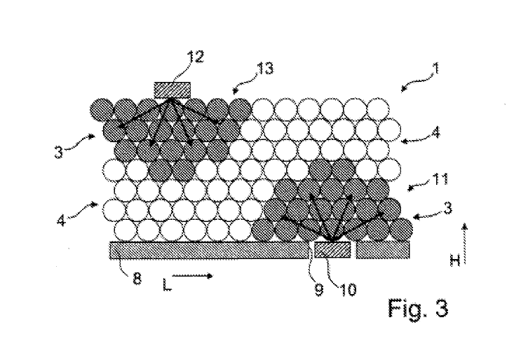

FIG. 3 shows a sectional view of a treatment of the particle mass in one embodiment of the method according to the invention;

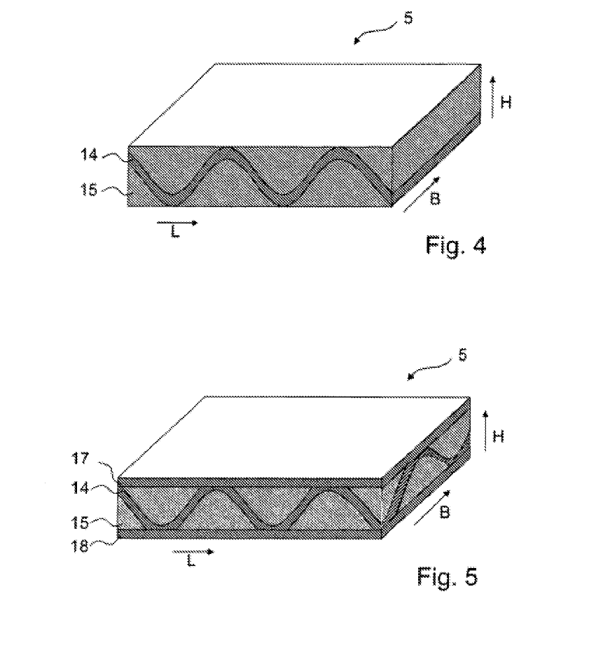

FIG. 4 shows a perspective sectional view of a particle-based element in the form of a plate produced with one embodiment of the method according to the invention;

FIG. 5 shows a perspective sectional view of a further particle-based element produced with one embodiment of the method according to the invention;

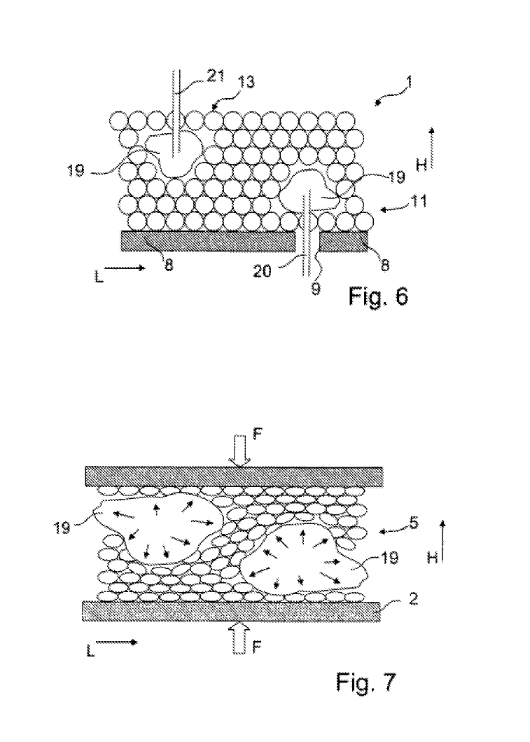

FIG. 6 shows a sectional view during the introduction of an expandable agent in one embodiment of the method according to the invention;

FIG. 7 shows a sectional view of the particle mass with the expandable agent during the compression operation in the embodiment of the method according to the invention;

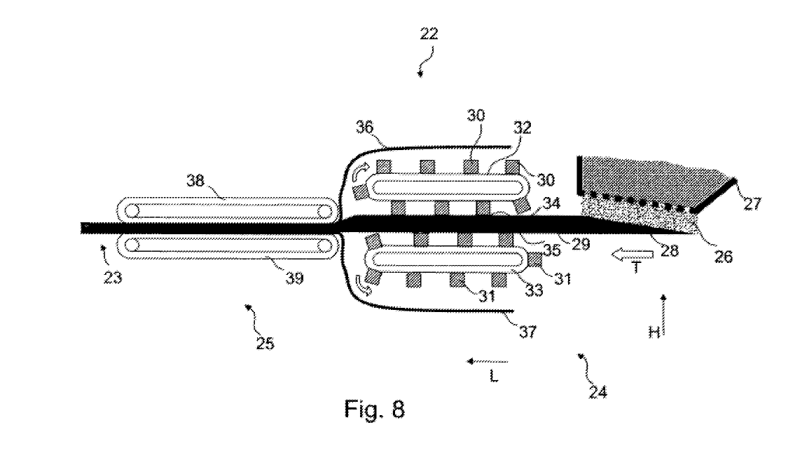

FIG. 8 shows a schematic view of a device for carrying out the method according to the invention;

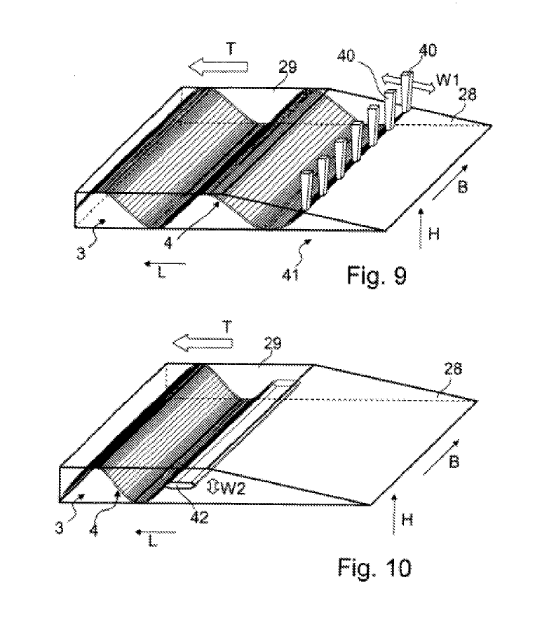

FIG. 9 shows a perspective view of the particle mass while it is being provided in one embodiment of the method according to the invention;

FIG. 10 shows a perspective view of the particle mass while it is being provided in one embodiment of the method according to the invention.

Below, a first embodiment of the method according to the invention will be illustrated with reference to FIGS. 1 and 2.

FIG. 1 shows, in a cross-sectional view, how a particle mass 1 with a plurality of particles is provided on a base 2. Here, a first part 3 of the particle mass 1, which is marked in FIGS. 1 and 2 by section lines, is selectively arranged in a second part 4 of the particle mass 1. The particles are represented as simply circular particles, while chips and/or fibers having a rather oblong shape can be generally also used as a particle mass for the method.

The individual areas of the first part 3 are completely surrounded by the second part 4 of the particle mass 1. Furthermore, the individual areas of the first part 3 are arranged in the longitudinal direction L alternately near the top side and near the bottom side of the particle mass 1.

The first part 3 of the particle mass 1 has different compressive properties with respect to the second part 4 of the particle mass. The different compressive properties can be achieved, for example, by the use of differently compressible particles, or by the use of differently interconnected particles.

The particle mass 1 represented in FIG. 1 is only a detail in the longitudinal direction L of the altogether provided particle mass. If a plate-like element is produced with the method according to the invention, the particle mass 1 has a significantly higher spreading in the longitudinal direction L with respect to the vertical direction H, where in the longitudinal direction L, the represented arrangement of the first part 3 and the second part 4 of the particle mass is repeated periodically or not periodically. As an alternative or in addition to the periodic structure, irregular arrangements can be provided. In particular, the quantitative proportion between the first part 3 and the second part 4 can be locally changed. This permits, for example, the reduction of weight in areas where less stability is required, or a local reinforcement of areas where connection means, such as screws, are to be provided.

The particle mass 1 is then compressed by means of a compression operation represented in FIG. 2 by applying a force F in the vertical direction H. By the different compressive properties, that means higher compressibility of the second part 4 with respect to the first part 3 of the particle mass 1, compaction is higher in the area of the second part 4 of the particle mass 1.

By the higher compression in certain local areas of the particle mass 1, structures of higher stability can be purposefully created. At the end of the compression operation, a particle-based element 5 is formed which, as is represented in FIG. 2, comprises areas of higher density and stability both in a top side area 6 and in a bottom side area 7, as well as a reinforcing wavy structure connecting the top side area 6 and the bottom side area 7.

FIG. 3 shows a possibility of achieving an inventive arrangement of the first part 3 of the particle mass 1 with respect to the second part 4 of the particle mass 1. Again, a particle mass 1 with a plurality of particles is provided on a base 8. The base 8 comprises a recess 9 in which a lower treatment tool 10 is arranged which acts on a locally lower part 11 of the particle mass 1. Furthermore, a treatment tool 12 is provided which acts on a locally upper part 13 of the particle mass 1. The locally lower and upper parts 11, 13 of the particle mass are shown in section lines.

The locally lower part 11 and the locally upper part 13 together form the first part 3 of the particle mass 1, while the remaining particle mass forms the second part 4.

In difference to the arrangement of the first part 3 and the second part 4 in FIG. 1, the first part 3 extends, in case of FIG. 3, down to the bottom side or up to the top side of the particle mass 1, respectively.

The action upon the particle mass 1 by the treatment tool 12 can be effected, for example, by means of heat treatment, permitting to pre-harden the particle mass in the areas 11, 13, so that the particle mass has a lower compressibility in the first part 3 and is thus, during the subsequent compression operation, less compressed than the second part 4 of the particle mass 1. By this, a particle-based element is created again which comprises defined areas of lower compression.

Also by applying a binder, such as an adhesive, the compressibility within the local lower part 11 and the local upper part 13 can be changed.

As an alternative, the treatment tools 10, 12, however, can also be employed to reduce the compressibility of the particle mass 1 in certain areas. This can be achieved, for example, by incorporating a chemical agent which softens the particle mass, whereby the particle mass can be compressed to a greater extent in the treated area.

In an environmentally friendly embodiment, water can be purposefully introduced into parts of the particle mass, whereby a particle mass of organic fibers, in particular wood chips, can be softened and thus higher compression of this part is achieved during the compression operation.

In FIG. 4, a perspective view of a plate-like, particle-based element is represented which can be produced by means of the method according to the invention. The particle-based element is in particular a chipboard of wood chips or a fiberboard of natural fibers. The particle-based element 5 is represented as a sectional view in the longitudinal direction L and in the width direction B, so that the arrangement of the areas of different stabilities inside the element 5 can be illustrated.

The particle-based element 5 comprises an area of higher stability 14 which extends in waves in the longitudinal direction L of the particle-based element 5 and is embedded in an area of lower density 15. The area of increased stability extends from a bottom side area to a top side area of the particle-based element 5. The area of increased stability 14 is in particular formed by the more compressed part of the particle mass.

The fact that the area of increased stability 14 extends from a bottom side area to a top side area of the particle-based element 5 and continuously extends in the latter causes an increase in the structural stability of the particle-based element. The flexural strength of the particle-based element 5 is increased by the area of increased stability connecting, by its wavy shape, areas outside the neutral zone of the plate-like particle-based element 5. The flexural strength of the particle-based element 5 is in particular increased in the width direction B.

The area of increased stability is formed by the second part 4 of the particle mass 1 as represented in FIG. 3. The first part 3 of the particle mass forms the area of low density 15.

In FIG. 5, a plate-like, particle-based element 5 produced by means of a method according to the invention is represented in a perspective sectional view in the width direction B and in the longitudinal direction L. In this particle-based element 5, the area of increased stability 14 extends in waves both in the longitudinal direction L and in the width direction B.

Again, the area of increased stability 14 extends from a bottom side area to a top side area of the particle-based element 5.

In the top side area, the particle-based element 5 comprises an upper layer of increased stability 17 which forms a surface of the particle-based element 5. In the bottom side area, the particle-based element 5 comprises a lower layer of increased stability 18 which forms a bottom side of the particle-based element. The wavy area of increased stability 16 seamlessly transitions into the upper layer 17 and the lower layer 18. The remaining area 15 of the particle-based element 5 forms an area of lower density.

The upper layer 17 and the lower layer 18 are preferably also formed by the second part 4 of the particle mass 1, as is represented in FIG. 1. As an alternative, additional particles can also be arranged in this area before the compression operation, these particles causing the increased stability of the upper layer 17 and the lower layer 18. In addition or as an alternative, an upper layer and a lower layer can be applied as a separate component before or after compression.

Thus, by the method according to the invention, a particle-based element 5 according to FIG. 5 can be produced which comprises an increased structural stability and a high stability in the area of the top and bottom sides at a relatively low weight.

In FIG. 6 and FIG. 7, a further embodiment of the method according to the invention is represented in a sectional view.

In FIG. 6, the particle mass 1 is provided on a base 8 which again comprises a recess 9. Through the recess 9, a lower treatment tool 20 is provided by means of which an expandable agent, here polyurethane 19, can be introduced into a local lower part 11 of the particle mass 1.

Similarly, an upper treatment tool 21 is disposed from above into the particle mass 1 such that polyurethane 19 can be introduced into a local upper part 13.

After the polyurethane 19 has been introduced, the particle mass 1 is disposed between a base 2 and a top part of a press and subjected to a compression operation with the force F in the vertical direction H.

The reaction of the polyurethane 19 with moist ingredients of the particle mass 1 and/or air causes the polyurethane 19 to foam, as is represented in FIG. 7 by the arrows without reference numerals, so that in the local lower part 11 and in the local upper part 13 of the particle mass 1, the compressibility is lower than in the area where no polyurethane 19 has been introduced. This leads to a compression of the ingredients of the particle mass 1 to different degrees of compression, whereby a particle-based element 23 having a desired local compression can be formed.

The foaming of the polyurethane 19 can furthermore also be triggered by additionally introducing energy, heat or water.

The particle-based element 5 produced in this way has the advantage that in those areas where polyurethane 19 has been introduced, a lower weight can be achieved with a simultaneously stable connection to the adjacent areas of increased stability.

In contrast to the schematic FIGS. 6 and 7, the polyurethane 19 and the particle mass 1 at least partially mingle.

In FIG. 8, a system 22 for continuously producing a particle-based element 23 by means of an inventive method is represented in a sectional view.

The plant 22 is generally divided into a provision device 24 and a subsequent compression device 25.

First, particles 26 are sprinkled from a container 27 onto a non-depicted conveyer element, such as a conveyor belt, and transported in the conveying direction T.

At the end of the sprinkling process, the particle mass 28 will form a particle mat 29 with a generally uniform thickness in the vertical direction H. The particle mat 29 is conveyed to a plurality of upper tools 30 and lower tools 31 permitting the selective arrangement of a first part of the particle mass in a desired matrix consisting of a second part of the particle mass.

The upper and lower tools 30, 31 are each fixed to an upper circulating belt 32 or a lower circulating belt 33, respectively. The upper belt 32 and the lower belt 33 circulate at such a speed that the tools 30, 31 located at or near the particle mass move at the same speed as the particle mass 29 in the conveying direction T.

For the design of the tools 30, 31, various alternatives are possible in the shown embodiment.

First of all, it is possible to design the tools 30, 31 as particle supply tools which introduce further particles into a local upper part 34 and a local lower part 35 of the particle mat 29, the further particles forming a first part of the particle mass comprising compressive properties different from those of the other, second part of the particle mass 28 that was sprinkled from the container 27.

However, as an alternative, the tools 30, 31 can also be designed as treatment tools which treat the particle mat 29 each in the local upper area 34 and the local lower area 35 such that a first part of the particle mass in these areas and a second part of the particle mass, which is formed by the non-treated part of the particle mat 29, have different compressive properties.

As an alternative, it is also possible to design the tools 30, 31 for the introduction of an expandable agent into the local upper part 34 and the local lower part 35 of the particle mat 29.

The tools 30, 31 can comprise attachments that project into the particle mat 29. By this, the tools 30, 31 are particle supply tools; it is also possible to introduce particles into the inside of the particle mat 29. If the tools 30, 31 are treatment tools, the inside of the particle mat 29 can be furthermore purposefully treated. If expandable agents are used, an introduction of the expandable agent can be implemented, as is represented in FIG. 6.

After the selective arrangement of the first part in the second part of the particle mass by means of the tools 30, 31, an upper layer 36 and a lower layer 37 are placed onto the top or bottom side, respectively, of the particle mass 29. The upper layer 36 and the lower layer 37 are formed from a resistant material which forms the surface of the particle-based element.

The particle mat 29 is supplied, together with the upper layer 36 and the lower layer 37, to the compression device 25 which is formed by an upper pressing tool 38 and a lower pressing tool 39. The pressing tools 38, 39 are configured as circulating belts and thus permit to compress the particle mat 29, the upper layer 36, and the lower layer 37 in a continuous compression operation. At the end of the compression operation, the particle-based element 23 is finished.

In FIG. 9, an alternative possibility of arranging a first part 3 of the particle mat 29 in a second part 4 is represented. Here, tools 40 are arranged in a sprinkling area 42 of the particle mass 28. As in the previous embodiment of the method according to FIG. 8, the particle mass 28 is again provided by sprinkling it from a container 27 in the sprinkling area 41 while it is simultaneously conveyed in the conveying direction T. The tools 42 are designed to perform a continuous, periodic reciprocating motion in the direction W1 along the top side of the particle mass 28 in the sprinkling area 41, so that a second part 4 arranged in waves with respect to the first part 3 of the particle mat 29 is obtained.

The tools 40 can again either supply additional particles, treat the existing particles in the sprinkling area 41, or introduce an expandable agent into the particle mass 28.

As an alternative to the represented plurality of tools 40, one tool disposed continuously across the total width can also be provided.

The first part 3 of the particle mat 29 is represented to be transparent so that the arrangement of the second part 4 can be better identified. Furthermore, the second part 4 comprises a certain characteristic in the vertical direction H that was neglected for a better representation.

In FIG. 10, the arrangement of the particle mass 28 is again represented, wherein a particle mat 29 with a second part 4, which is disposed in waves in the first part 3, is created. For this, a tool 42 is provided in the conveying direction T downstream of the sprinkling area 41, the tool being arranged within the particle mass 28 and moving in the direction of the tool's movement W2, i.e. in the vertical direction. By the flat design of the tool 42, the particle mass 28 flows past the tool 42 without any essential deflection in the conveying direction T.

At its end facing away from the sprinkling area 41, the tool 42 permits a selective arrangement of the second part 4 with respect to the first part 3 of the particle mass 28. For this, an opening can be provided in the tool 42 in one embodiment which permits to introduce further particles. In another embodiment, the tool 42 permits the purposeful treatment of the particle mass 28. In still a further embodiment, an expandable agent is introduced into the particle mass 28 by means of the tool 42.

To permit a wavy arrangement of the second part of the particle mass both in the longitudinal direction L and in the width direction B, the tool can be arranged such that it extends in the width direction B with a waveform in the longitudinal direction L or the conveying direction T, respectively.

To obtain a wavy form of the second part of the particle mass in the width direction B, a stationary tool can also be provided within the particle mass which extends in the width direction with a waveform formed in the vertical direction H.

It is furthermore possible to arrange tools in different positions in the conveying direction T in the sprinkling area, so that the tools arranged upstream rather treat a lower area of the particle mass, while the tools arranged further downstream rather treat an upper area of the particle mass. Here, too, instead of a treatment, the introduction of another type of particles can be provided.

It should be emphasized in general that the production of the particle-based element cannot only be carried out by means of a flowing process, as is represented in the embodiments in FIGS. 8 to 10, but also by stationarily arranging the first part and the second part and compressing the particle mass in a stationary plate, contact or platen press.

For conglutinating the particles, in particular the wood chips or natural fibers employed as particles in a plurality of applications, different binders can be used. An often employed binder is urea-formaldehyde resin (UF resin). As an alternative, phenol formaldehyde resins can be used which moreover have the advantage of being water-resistant. Furthermore, a plurality of mixed resins containing phenol and/or melamine can be employed as binder. The chips can also be bound by means of isocyanate.

Furthermore, the individual chips can be connected with adhesives. The use of natural adhesives, for example of lignine, tannin, carbohydrates, bone glue or protein glues, is possible. In general, however, other adhesives, such as epoxy resin, can also be used.

Apart from the different compressive properties of the first part and the second part of the particle mass, in the method according to the invention, particle types with further differences permitting various advantages that will be briefly discussed below can be provided.

Thus, already during the arrangement of the particle mass, a different density of the first and the second part of the particle mass can be provided, whereby the weight and stability property of the particle-based element can be decisively influenced.

Furthermore, particles of different hardness can be provided to locally increase the hardness of the particle-based element.

However, particles with different brittleness and thus different behaviors at rupture can be provided, so that, for example, the brittleness of the structurally supporting part of the particle-based element can be selectively reduced, while for the other areas of the particle-based element, particles of minor quality can be used.

The elasticity of the particle-based element can be purposefully influenced by the elasticity of one part of the particle mass being different from that of another part of the particle mass. By this, the elasticity of the particle-based element per se as well as the local resilience of the particle-based element can be adapted to different applications.

Furthermore, there might be structural differences, e.g. of the particle size and/or particle geometry of the first part of the particle mass and the second part of the particle mass.

Other properties of the particle mass can also be influenced in a suited manner for a plurality of applications. For example, the magnetic permeability of a part of the particle mass can be purposefully changed, for example to permit to shield electromagnetic radiation.

Furthermore, the thermal properties of parts of the particle mass can be influenced to permit the employment of the particle-based element also in regions of elevated or low temperatures. Further differences of the parts of the particle mass can relate to the viscosity, the melting behavior and the boiling behavior.

Moreover, for certain applications, an arrangement of the particle mass with different electric conductivities can be of interest. In still other applications, different light stabilities of the first and the second parts of the particle mass can be provided.

1. A method for producing a particle-based element, the method comprising the steps of:
providing a particle mass with a plurality of particles, and compressing the particle mass;
selectively arranging a first part of the particle mass in a desired matrix including a second part of the particle mass in the course of providing the particle mass; and
forming the second part of the particle mass in waves in a longitudinal direction of the particle-based element between a bottom side area and a top side area of the particle-based element;
wherein the first part of the particle mass and the second part of the particle mass comprise different compressive properties.

2. The method according to claim 1 wherein compressing the particle mass is performed such that the particle-based element is formed with areas of different densities, and wherein the particle mass comprises particles of essentially identical densities before compression.

3. The method according to claim 1, wherein the method is performed such that the second part of the particle mass is arranged in a continuous matrix.

4. (canceled)

5. The method according to claim 1 wherein the second part of the particle mass is compressed to a greater extent than the first part of the particle mass during compression.

6. The method according to claim 1 wherein the first part of the particle mass is compressed to a greater extent than the second part of the particle mass during compression.

7. (canceled)

8. The method according to claim 1 further comprising forming the second part of the particle mass in waves in a width direction of the particle-based element.

9. The method according to claim 1 wherein the first and second parts of the particle mass comprise different types of particles.

10. The method according to claim 9 wherein during the provision of the particle mass, a first type of particles is conveyed, and a second type of particles is supplied to the first type of particles by a particle supply tool before the particle mass is compressed.

11. The method according to claim 1 further comprising treating the first part and/or the second part of the particle mass.

12. The method according to claim 11 wherein the treating includes introducing a chemical agent.

13. The method according to claim 11, wherein the treating includes introducing water.

14. The method according to claim 11 wherein the treating includes introducing energy.

15. The method according to claim 11 further comprising conveying the particle mass in the longitudinal direction during the treating, wherein the treating is effected by a tool that is arranged within the particle mass and that is moved in a vertical direction.

16. The method according to claim 15 wherein the tool extends in waveform with respect to the longitudinal direction.

17. The method according to claim 1 further comprising introducing an expandable agent into the first part of the particle mass, wherein the expandable agent expands after compression into a foam within the particle mass.

18. The method according to claim 2 wherein compressing the particle mass is performed such that the second part of the particle mass is compressed to a greater extent than the first part of the particle mass.

19. The method according to claim 2 wherein compressing the particle mass is performed such that the first part of the particle mass is compressed to a greater extent than the second part of the particle mass.
